(19) United States
(12) Patent Application Publication
(10) Pub. No.: US 2005/0050194 A1
(43) Pub. Date: Mar. 3, 2005

(54) Method and system for proxying a message

(76) Inventors: Bernhard Honeisen, Bettwiesen (CH); Jani Ekman, Kangasala (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/500,920

(22) PCT Filed: Apr. 3, 2002
(86) PCT No.: PCT/IB02/01083

(30) Foreign Application Priority Data
Jan. 10, 2002 (WO) PCT/EP02/00190

(51) Int. Cl. H04B 15/00

(52) U.S. Cl. 709/224; 702/190

(57) ABSTRACT

The present invention relates to a method and system for proxying or relaying a message to an application server, wherein a processing information indicating at least one allowable operating mode for processing said message is forwarded towards an application server (10, 40, 60). The message is then processed based on a selected one of the at least one allowable operating mode. The forwarding step may be performed by adding a header field to the message or by performing a mode negotiation function. Thereby, the application server (10, 40, 60) can be informed of acceptable alternative ways of handling incoming requests and a proxy network element (20) may continue a pre-established chain of application servers without the risk that the call or session may be terminated at the application server (10, 40, 60).

### FIELD OF THE INVENTION

The present invention relates to a method and system for proxying or relaying a message to an application server, in particular to a Session Initiation Protocol (SIP) application server in an Internet Protocol (IP) multimedia subsystem environment.

### BACKGROUND OF THE INVENTION

In order to achieve access independence and to maintain a smooth inter operation with wired terminals across the Internet, an IP multimedia system as specified e.g. in the 3GPP specification TS 23.228 has been developed to be conformant to IETF (Internet Engineering Task Force) “Internet standards”. The IP multimedia core network (IM CN) subsystem enables network operators of mobile or cellular networks to offer their subscribers multimedia services based on and build upon Internet applications, services and protocols. The intention is to develop such services by mobile network operators and other third party suppliers including those in the Internet space using the mechanisms provided by the Internet and the IM CN subsystem. The IM CN subsystem thus enables conversions of, and access to, voice, video, messaging, data and web-based technologies for a wireless user, and combine the growth of the Internet with the growth in mobile communications.

FIG. 1 shows a functional architecture for provision of service in an IP multimedia subsystem (IMS). The architecture is based on the principle that the service control for home subscribed services for a roaming subscriber is in the home network, e.g. a Serving Call State Control Function (S-CSCF) 20 is located in the home network. The S-CSCF 20 performs the session control service for a terminal device or User Equipment (UE). It maintains a session state as needed by the network operator for support of the services. Within an operator's network, different S-CSCFs may have different functionalities. The functions performed by the S-CSCF 20 during a session are e.g. registration, session flow management, charging and resource utilization management. When a subscriber roams to a visited network, the visited network supports a Proxy-CSCF (P-CSCF) which enables the session control to be passed to the home network based S-CSCF which provides the service control. The use of additional CSCFs, i.e. an Interrogating-CSCF (I-CSCF), to be included in the signalling part is optional. Such additional CSCFs may be used to shield the internal structure of a network from other networks.

According to FIG. 1, an application server (AS) 10 offering value added IM services resides either in the user's home network or in a third party location. The third party location could be a network or simply a stand-alone AS. An interface ISC is provided between the S-CSCF 20 and the AS 10 and is used to provide services residing in the AS 10. In particular, the AS 10 is a SIP application server arranged to influence and impact SIP sessions on behalf of the services, while the ISC interface is used to communicate with the S-CSCF 20. The S-CSCF 20 decides whether an application server is required to receive information related to an in-coming SIP session request to ensure appropriate service handling. The decision at the S-CSCF 20 may be based on (filter) information received from a subscriber database, e.g. a Home Subscriber Server (HSS) 30, or other sources, e.g. application servers. This filter information is stored and conveyed on a pure application server basis for each subscriber. Furthermore, a name and/or address information of the application server or servers is received from the HSS 30.

Additionally, an IM Service Switching Function (SSF) 60 is provided to host CAMEL (Customized Application for Mobile network Enhanced Logic) network features, such as trigger detection points, CAMEL Serving Switching Finite State Machine, etc., and to interface to a CAMEL service environment 70 via a CAMEL Application Part (CAP). Due to the fact that the S-CSCF 20 does not provide authentication and security functionality for secure direct third party access to the IM sub-system, an Open Service Access (OSA) framework consisting of a OSA service capability server (SCS) 40 and a OSA application server 50 are arranged to provide a standardized way for third party secure access to the IM subsystem.

The AS 10 may contain a service capability interaction manager (SCIM) functionality and other application servers. The SCIM functionality is an application which performs the role of interaction management. The internal components are represented by the dotted boxes inside the AS 10.

The protocol to be used on the ISC interface is the SIP as defined in the IETF specification RFC 2543. According to SIP, callers and callees are identified by SIP addresses. When making a SIP call, a caller first locates the appropriate server and then sends a SIP request. A typical SIP operation is the invitation. Instead of directly reaching the intended callee, a SIP request may be redirected or may trigger a chain of new SIP requests by proxies. A proxy server is a network element that makes requests of other network elements on behalf of the network elements it serves. Thus, the proxy server relays requests from the network element it serves through the outside world and relays the responses to the requesters. It acts as a relay between the real server and the client.

A SIP message is either a request from a client to a server, or a response from the server to a client. Both request and response messages use the generic-message format specified in the IETF specification RFC 822 for transferring entities, i.e. the body of the message. Both types of messages consist of a start-line, one or more header fields (also known as “headers”), an empty line, i.e. a line, with nothing preceeding a carriage-return line-feet (CRLF) indicating the end of the header fields, and an optional message body. A SIP leg is defined by the “Call-ID”, “To” and “From” header information fields with associated “tag” information fields. In practice, a SIP session may consist of one or more incoming legs and/or one or more outgoing legs between the S-CSCF 20 and the AS 10. The S-CSCF 20 may exhibit a proxy server like behavior by passing messages or service requests to the AS 10 or by passing the requests out of the system. Therefore, the S-CSCF 20 may route a session to the AS 10. The AS 10 may proxy the session back to the S-CSCF 20 or may terminate it. In the latter case, it acts either as a pure User Agent Server (UAS) or as a Back-to-Back User Agent (B2BUA).

FIG. 2A to 2C indicate possible modes of operation between the AS 10 and the S-CSCF 20. These operating modes may be utilized by the AS 10 to process SIP service requests. In FIG. 2A an operating mode is shown, where the AS 10 acts as a SIP proxy. In this mode of operation, the incoming SIP request is proxied by the S-CSCF 20 to the AS 10 which then acts as a proxy as specified in the IETF RFC 2543bis, proxying the request back to the S-CSCF 20 which then proxies it towards the destination. During the proxy operation, the AS 10 may add, remove or modify the header contained in the SIP request according to the proxy rules specified in RFC 2543bis. Furthermore, in FIG. 2B a mode of operation is shown, where the incoming SIP request is proxied by the S-CSCF 20 to the AS 10 which then acts as either a user agent or a redirect server, as specified in RFC 2543bis. Finally, in FIG. 2C, a mode of operation is shown, where the incoming SIP request (SIP leg #1) is proxied by the S-CSCF 20 to the AS 10 which then generates a new SIP request (SIP leg #2) for a different SIP leg or dialog which it sends to the S-CSCF 20 which then proxies it towards the destination. SIP leg #2 is based on #1, meaning that most of the header fields and payload(s) are the same. In this operating mode, the AS 10 behaves as a B2BUA for the multiple SIP legs, as specified in RFC 2543bis.

However, when the name and/or address of more then one application server is transferred from the HSS 30, the S-CSCF 20 may have to contact more than one application server in the order supplied by the HSS 30, wherein the response from the first application server may be used as an input to the second application server. Then, this operation is not possible if the AS 10 acts in an operating mode which terminates the SIP session, as no further application servers can be contacted.

### SUMMARY OF THE INVENTION

It is therefore an object of the present invention to provide a method and system for proxying a message to an application server, by means of which system functions can be performed in a correct and pre-defined way.

This object is achieved by a method of proxying or relaying a message to an application server, said method comprising the steps of:
receiving said message;
forwarding towards said application server a processing information indicating at least one allowable mode for processing the message; and
processing said message based on a selected one of said at least one allowable operating mode.

Furthermore, the above object is achieved by a system for proxying or relaying a message to an application server, said system comprising:
session control means for receiving said message and for generating and forwarding towards said application server a processing information indicating at least one allowable operating mode for processing said message;
wherein said application server is arranged to process said message based on the selected one of said at least one allowable operating modes.

Additionally, the above object is achieved by a network element for proxying or relaying: a message to an application server, said network element being arranged to generate and forward towards said application server a processing information indicating at least one allowable operating mode for processing said message.

Moreover, the above object is achieved by an application server for receiving a message proxied or relayed from a network element, said application server being arranged to process said message based on a processing information received from said network element and indicating at least one allowable operating mode for said processing.

Accordingly, a way to indicate allowable or non-allowable modes to an application server or intermediate network node is provided so as to assure that the application server or intermediate network node proxies the service request or session back to the proxying network element, e.g. the S-CSCF, or to any other desired network node. Thus, the termination of a session can be restricted in cases where, the filtering leads to the result that more than one application server are to be contacted in a chain, so that the pre-established chain of application servers can be continued. Therefore, system functions can be performed in a correct and pre-defined way. Furthermore, the application server or other network node can be informed of acceptable alternative ways of handling incoming service requests, e.g. if the application server is capable of handling the same (initial) request in multiple ways it can limit the possibility of unnecessary exceptions due to a failure indication from the proxying network element by behaving according to the allowed or negotiated rules. Moreover, specific operating modes, such as the B2BUA mode can be avoided in certain scenarios.

On the other hand, the application server can inform the proxying network element, e.g. S-CSCSF, which modes it requires to perform a service to be executed for a subscriber in question.

Additionally, the cases the proxying network element has to be prepared to can be limited, and thus fewer resources are needed in the proxying network element, e.g. the S-CSCF. It has been shown, that the B2BUA case at application servers turns out to be rather complicated and resource consuming. With the present invention, being prepared for the B2BUA case can be avoided in most of the sessions. If the sessions, where B2BUA at application servers is allowed, are limited, the likelihood for failures at the proxying element (e.g. S-CSCF) is smaller. This also depends on the mechanisms for mapping the outgoing and incoming dialog.

According to an advantageous further development, the forwarding step may be performed by adding to said message a header field or a sub-field of a header field, indicating said allowable operating modes. In particular, the header field may be an extension header field.

Furthermore, the forwarding step may be performed by adding to said message a first route header pointing to said application server and a second route header pointing back to the proxying or relaying network element. In this case, the first and second route headers indicate the allowable operating modes, since the application server cannot act as a user agent server when the second route header is left at the application server after it has removed its own route header. As an additional option, a header extension field may be added to the second route header. The header extension field then indicates that the second route header is to be ignored if the application server is operated in a user agent server mode. If this header extension field is added, the application server may ignore the second route header and may thus still act as a user agent server.

As a further option, the forwarding step may be performed by adding to the message only one route header pointing to said application server. In this case, the single route header indicates the allowable operating mode, as there is no route header back to the proxying or relaying network element and the application sever thus has to act as a user agent server and cannot act as a proxy or a back-to-back user agent.

Alternatively, the processing information may be forwarded in a body or payload portion of the message. The processing information may be carried as a flag information set in the header or payload portion. Thereby, the application server can be directly informed of the allowable modes without any additional signalling requirements. According to another advantages further development, the forwarding step may be performed using a mode negotiation function. This mode negotiation function may be achieved by adding to a SIP Options message a header field indicating the allowable operating modes. Alternatively, the mode negotiation may be performed during a registration to the application server. Thus, using the negotiation feature, the support of a particular operating mode can be guaranteed.

Furthermore, a checking function may be provided for checking the possibility of said forwarding step by adding a corresponding requirement information to said service request. In particular, the requirement information may be a predetermined tag in a Proxy-Require header field of said service request. Thus, it can be made sure right from the beginning whether the application server supports the mode forwarding feature. Due to the fact that the requirement information e.g. the Proxy-Require header field, requires an error response if the specified feature is not supported, a response is guaranteed if the feature is not supported.

According to a further advantageous development, the processing information may be added to a filter information. Thereby, mode information can be signalled or downloaded e.g. as a kind of initial or subsequent filter criteria upon user registration or at application execution time.

The allowable operating modes may be at least one of a proxy server mode, a back-to-back user agent mode, a user agent server mode, and a user agent client mode.

### BRIEF DESCRIPTION OF THE DRAWINGS

In the following, the present invention will be described on the basis of preferred embodiments with reference to the accompanying drawings in which:

FIG. 1 shows a schematic diagram of a functional architecture for the provision of service in an IMS where the present invention can be implemented;

FIG. 2A-2C show schematic diagrams indicating operating modes which may be utilized by an application server;

FIG. 3 shows a signalling and processing diagram indicating a proxying procedure according to a first preferred embodiment;

FIG. 4 shows a signalling and processing diagram indicating a proxying procedure according to a second preferred embodiment;

FIG. 5 shows a signalling and processing diagram indicating a checking procedure for checking the support of the procedures according to the first and second embodiments;

FIG. 6 shows a schematic diagram indicating an alternative procedure for transferring a mode information in a proxying procedure according to a third preferred embodiment;

FIG. 7 shows a signalling and processing diagram indicating a proxying procedure according to the third preferred embodiment; and

FIG. 8 shows a signalling and processing diagram indicating a proxying procedure according to a fourth preferred embodiment.

### DESCRIPTION OF THE PREFERRED EMBODIMENTS

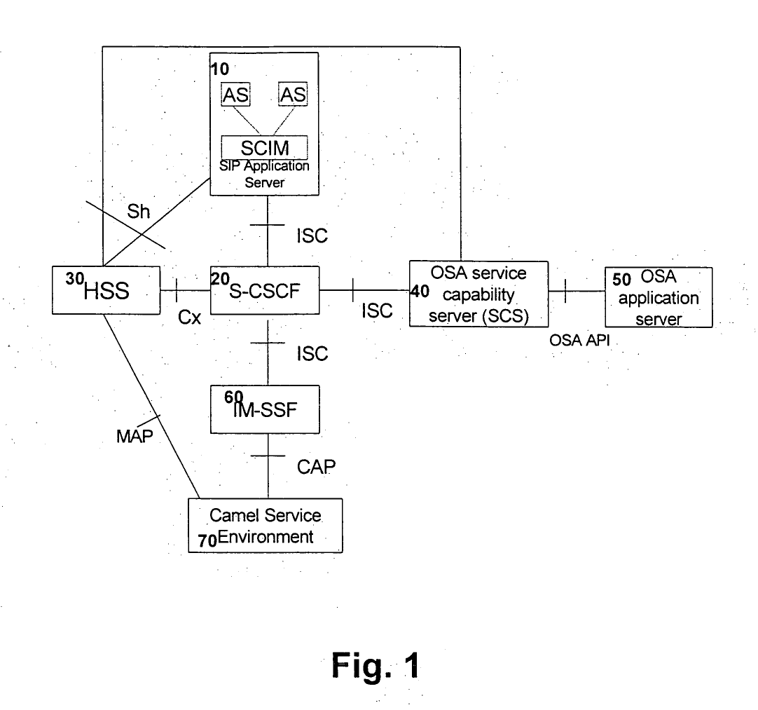

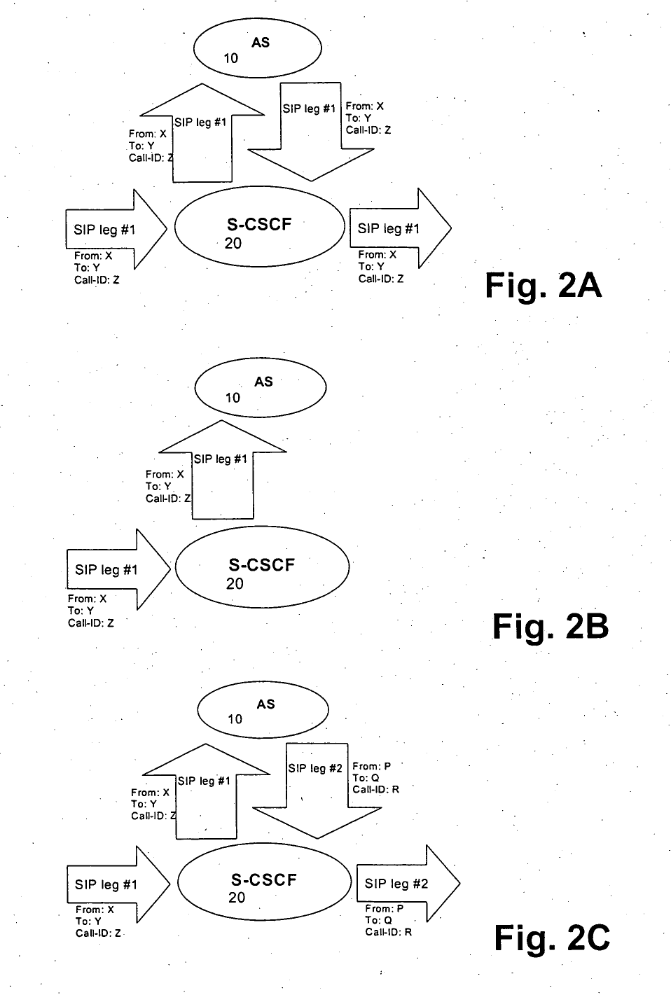

The preferred embodiments will now be described on the basis of a IMS as shown in FIG. 1.

According to the first preferred embodiment, a header field is added to a SIP request at the S-CSCF 20 to thereby indicate allowed operating modes which may be utilized by the AS 10. In particular, a new header field is defined in the SIP request, e.g. the SIP Invite message, indicating that a user or service is being invited to participate in a session. This extension header field contains the allowed modes (e.g. proxy, UAS, B2BUA) which the AS 10 is allowed to utilize. Furthermore, the S-CSCF 20 may use this header field to indicate the modes of the AS 10, it can handle. This may be useful in a session controller implementation.

As another example, it could be defined in the S-CSCF 20 that for a message (directed to e.g. a recipient subscriber) the allowable operating modes of the AS 10 or another AS at the terminating side are limited to “proxy” meaning that it cannot be multiplied and/or copied to anyone else by the service logic executed in the AS.

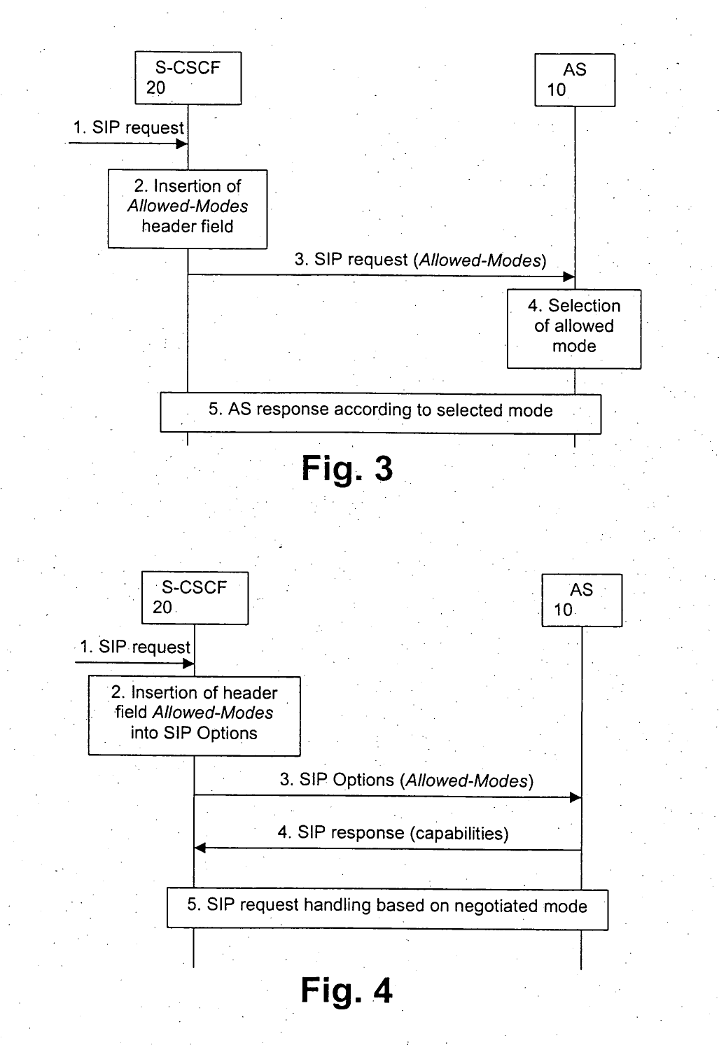

FIG. 3 shows a signalling and processing diagram indicating a proxying or relaying procedure according to the first preferred embodiment. When the S-CSCF 20 receives a SIP request, e.g. a SIP INVITE message (step 1), it determines the allowed modes, e.g. proxy and B2BUA, based on the specified service or session and inserts an Allowed-Modes header field to the SIP request to indicate operating modes the AS 10 can utilize for processing the SIP request (step 2). Then, in step 3, the SIP request with the added Allowed-Mode header field is relayed or proxied by the S-CSCF 20 to the AS 10. Based on the information given in the Allowed-Modes header field, the AS 10 selects a suitable allowed mode, e.g. proxy (step 4) and processes the SIP request accordingly, e.g. proxies the SIP INVITE message back to the S-CSCF 20. Thus, a processing response is selected at the AS 10 according to the selected allowed mode (step 5). In case a mode is selected, where the SIP request is proxied at the AS 10 back to the S-CSCF 20, the S-CSCF 20 removes the Allowed-Modes header field before sending it further. Accordingly, the new Allowed-Modes header field only appears on the ISC interface. According to another example, the AS 10 could be instructed to terminate the dialog and do not route the request or message back, i.e. the allowed mode is then the UAS mode.

In the following, examples for different header fields of the SIP request are given.

### EXAMPLE 1

In case the AS 10 is only allowed to proxy the SIP request, the header field may look as follows:
[...]
Allowed-Modes: proxy
[...]

### EXAMPLE 2

In case the AS 10 is allowed to either proxy or terminate the incoming SIP request the header field may look as follows:
[...]
Allowed-Modes: proxy, UAS
[...]

### EXAMPLE 3

In case the AS 10 is allowed to initiate sessions, in addition to the example 2, the header field may look as follows:
[...]
Allowed-Modes: proxy, UAS, UAC
[...]

### EXAMPLE 4

In case an advanced session handling is allowed by the AS 10, the header field may look as follows:
[...]
Allowed-Modes: proxy, UAS, UAC, B2BUA
[...]

If the AS 10 is in the UAC mode, the procedure according the present invention may as well be used by the AS 10 for indicating to the S-CSCF 20 how to treat a SIP request originated at the AS 10. E.g., the S-CSCF 20 could be forced to proxy the SIP request to another network node. Alternatively, to perform a specific service, the AS 10 might need to be able e.g. to use the UAS mode.

FIG. 4 shows a signalling and processing diagram indicating a proxying procedure according to the second preferred embodiment. In the second preferred embodiment, the forwarding of the allowed modes is based on a mode negotiation between the S-CSCF 20 and the AS 10, wherein the required operating modes are negotiated against the supported modes of the S-CSCF 20. As an alternative, the AS 10 may query the acceptable modes as defined by the S-CSCF 20. This might be performed once per subscriber or once per subscription.

When the S-CSCF 20 receives a SIP request, e.g. a SIP REGISTER message (step 1), it generates a SIP OPTIONS message and inserts the Allowed-Modes header field into this message. Using the OPTIONS message, all ASs defined in the subscriber's filtering information are queried as to their capabilities. This may be performed at registration time for the whole registration or at the time a request occurs. If the AS 10 supports the Allowed-Modes feature, it may respond to this SIP request with a response message, e.g. a SIP 200 OK message, comprising a capability set with the mode needs of the AS 10. This may be performed by returning an Allow header field indicating the supported operated modes. Alternatively, the syntax could be a new payload including the mode information. The AS 10 may inform per subscriber or in general, which modes it can handle.

In the present case, the S-CSCF 20 forwards the SIP Options message with the Allowed-Modes header field to the AS 10 (step 3) which may respond with a SIP-response indicating its capabilities (step 4). Then, the S-CSCF 20 knows in advance, which modes the AS 10 supports, and may decide on the further handling of the received SIP request based on the negotiated mode (step 5).

Thus, according to the second preferred embodiment, the SIP Supported header field, i.e. “I support the modes feature as such” together with the above described Allowed-Modes extension header field (“I support the following modes”) can be used in the SIP Options message, as indicated in the following header example:
[...]
Supported: mode-negotiation
Allowed-Modes: proxy, UAS
[...]

Wherein the S-CSCF 20 indicates that the AS 10 may either proxy or terminate the incoming SIP request.

The mode negotiation may always be performed as per initial request or may be performed once for all subsequent sessions including registrations, session invitation request, etc. or could even be performed per subscriber or subscription. As already mentioned, the above SIP Options message may as well be used by the AS 10 to derive the operating modes acceptable by the S-CSCF 20.

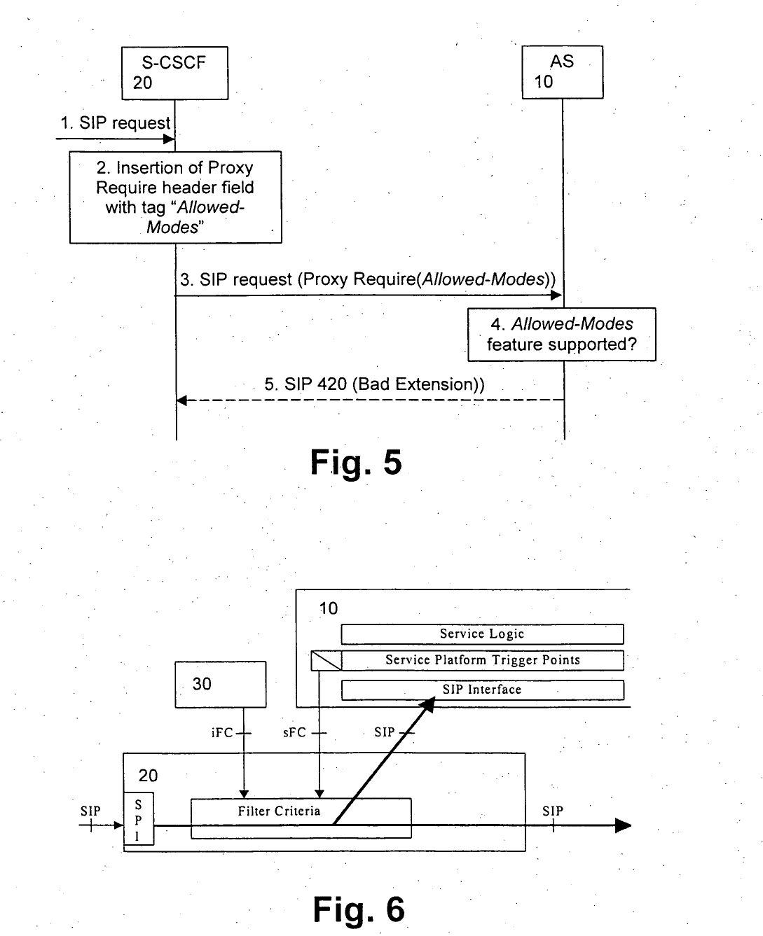

FIG. 5 shows a signalling and processing diagram indicating an additional checking procedure for providing the S-CSCF 20 with an assured response if the AS 10 does not support the mode forwarding or negotiation features according to the first and second embodiments.

If the AS 10 does not support the above features, a default handling procedure could be defined at the S-CSCF 20 so as to be prepared for “unacceptable” scenarios. Especially, all network elements which may act as a B2BUA must implement at least one of the above features to assure proper operation. The procedure defined in FIG. 5 may be used by the S-CSCF 20 to make sure that the AS 10 supports the mode forwarding or negotiation features.

In particular, according to FIG. 5, if a SIP request is received at the S-CSCF 20 (step 1) a Proxy-Require header field with a tag “Allowed-Modes” is inserted to the SIP request.

The Proxy-Require header field is used to indicate proxy-sensitive features that must be supported by the proxy. Any Proxy-Require header field features that are not supported by the proxy must be negatively acknowledged by the proxy to the client if not supported. Thus, this header field can be used by clients to tell user agent servers about options that the client expects the server to support in order to properly process the request. If a server does not understand the option, it must respond by returning e.g. a status code 420 (Bad Extension) and list those options it does not understand in the unsupported header. This is to make sure that the client-server interaction will proceed without delay when all options are understood by both sides, and only slow down if options are not understood.

In the present case shown in FIG. 5, the S-CSCF 20 proxies the SIP request including the Proxy-Require header field with the Allowed-Modes tag to the AS 10 (step 3). If the AS 10 supports the feature, it processes the SIP request based on the allowed modes which may be indicated in SIP request. Alternatively, the AS 10 may start a mode negotiation in case of a SIP request according to FIG. 4. However, if the AS 10 does not support the Allowed-Modes feature, it responds with an error message, e.g. the SIP 420 message, so as to indicate that it does not support this features. Thus, the S-CSCF 20 may use this checking procedure to assure support of the Allowed-Modes feature.

FIG. 6 shows a schematic diagram indicating an alternative procedure for transferring a mode information to the S-CSCF 20, according to the third preferred embodiment. In the third preferred embodiment, the mode information is added to an AS contact information contained in a filter information, e.g. Initial Filter Criteria (iFC), stored in the HSS 30 and downloaded to the S-CSCF 20 upon user registration, or in a filter information, e.g. Subsequent Filter Criteria (sFC), signalled from the AS 10 to the S-CSCF 20 at application execution time. Further information on the underlying filter operations can be gathered from the 3GPP specification TS 23.218.

The filter information the SCSF 20 receives from the AS 10 defines relevant Service Points of Interest (SPIs) for a particular application. The SPIs are points in the SIP signalling that may cause the S-CSCF 20 to proxy or relay a SIP message to the AS 10 or any other server connected by the ISC interface. The subset of all possible SPIs which are relevant to a particular application are defined by means of the respective filter information.

According to FIG. 6, an SPI processing functon in the S-CSCF 20 instructs a proxying or relaying procedure based on filter criteria received from the HSS 30 and/or the AS 10. The AS 10 may or may not use the Allowed-Modes feature in defining the service logic to be executed, e.g., services requiring an operating mode not indicated in the Allowed-Modes information are not executed by the AS 10. In the second preferred embodiment, a negotiation of the allowed modes as requested by the S-CSCF 20 and/or required modes as requested by the AS 10 takes place by an SIP signalling. In the present filtering based third embodiment, an information concerning the modes requested by the AS 10 is contained in the filter information (e.g. sFC) transferred from the AS 10 to the S-CSCF 20. Furthermore, the information concerning the modes allowed by the S-CSCF 20 may be contained in the filter information (e.g. iFC) transferred from the HSS 30 to the S-CSCF 20. Thereby, respective mode information required for the proxying procedure can be transferred to the S-CSCF 20.

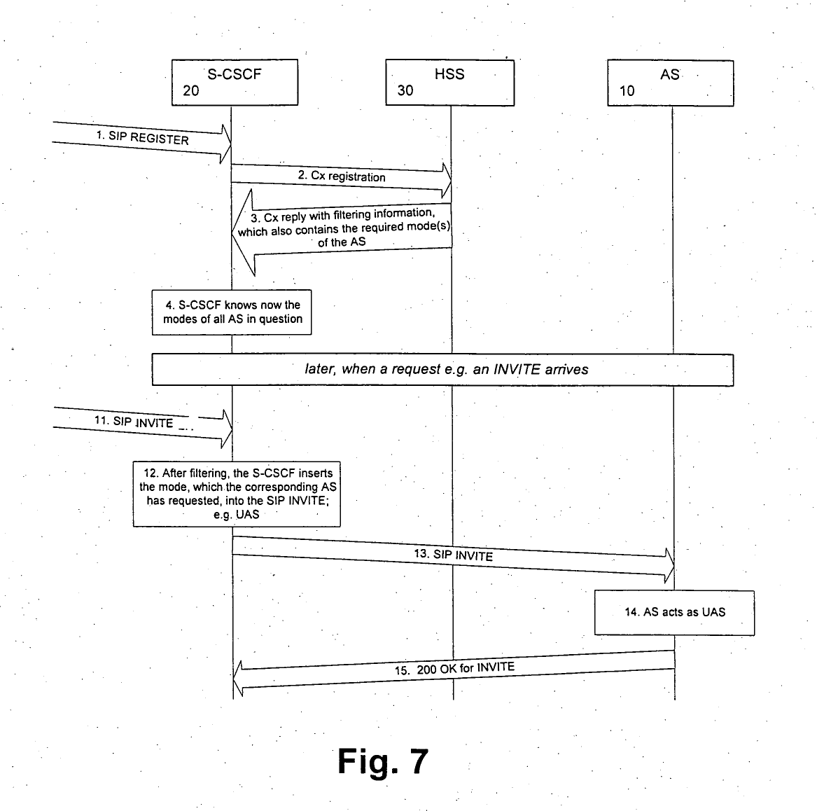

FIG. 7 shows a signalling and processing diagram indicating a proxying procedure according to the third preferred embodiment. When a SIP request, e.g. a SIP REGISTER message, is received in step 1, the S-CSCF 20 sends a registration message to the HSS 30 (step 2) and receives from the HSS 30 a reply message with the filtering information which also contains the required mode(s) of the concerned ASs (step 3). Then, the S-CSCF 20 can derive and store the modes of all ASs in question (step 4). At a later point in time, when a SIP request, e.g. a SIP INVITE message, arrives at the S-CSCF 20 (step 11), it determines the concerned ASs from the filtering information and inserts the mode information, e.g. UAS mode, which the corresponding AS, e.g. the AS 10, has requested into the SIP request (step 12). Then, the modified SIP request is forwarded to the AS 10 in step 13. The AS 10 may now act in the UAS mode (step 14) and sends an acknowledgement, e.g. a SIP 200 OK message, to the S-CSCF 20 (step 15).

The procedure according to the third embodiment provides the advantages that it is independent from the AS registration procedure and does not increase the call setup delay at filtering time.

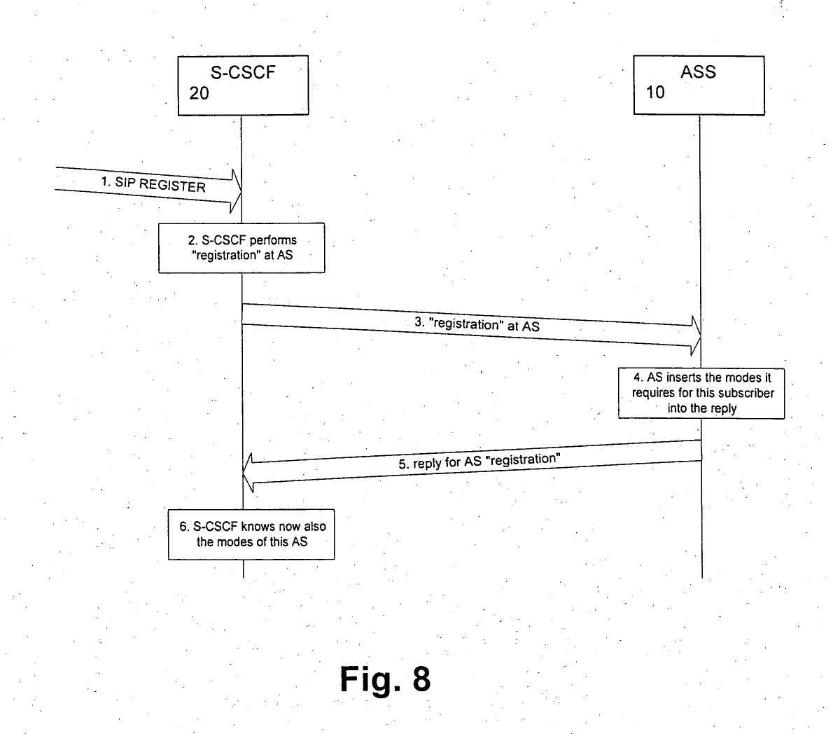

FIG. 8 shows a signalling and processing diagram indicating a proxying procedure according to a fourth preferred embodiment, wherein the allowed or required modes are negotiated during the registration procedure to the AS 10. The mode information is exchanged at the same time or within the same SIP transactions.

According to FIG. 8, when an initial SIP request, e.g. a SIP REGISTER message, is received at the S-CSCF 20 in step 1, the S-CSCF 20 initiates a registration procedure at the AS 10 (step 2). A corresponding registration message is sent to the AS 10 (step 3), which then inserts the mode it requires for the particular subscriber into its reply message (step 4). The reply message with the mode information is returned to the S-CSCF 20 (step 5), and the S-CSCF 20 can derive the modes of the AS 10 from this reply message (step 6).

According to a fifth preferred embodiment, the signaling or forwarding of allowable operating modes may be based on a selection of at least one route header, e.g. the SIP Route header. In SIP, the S-CSCF 20 routes the session to the AS 10. As already mentioned, the AS 10 either proxies the session back to the S-CSCF 20 or terminates it. In the latter case it acts either as a pure user, i.e. UAS, or as a B2BUA. In case the AS-10 acts as a B2BUA, it terminates a first SIP session and triggers a new second SIP session which is based on the first SIP session.

The routing problem may be solved by inserting at the S-CSCF 20 a preloaded Route header pointing to the AS 10, followed by an additional Route header pointing back to itself, i.e. the S-CSCF 20.

According to the so-called Loose Routing principle, the routing decision is then based on the topmost Route header. Thus, by pushing additional proxies to the Route header “stack”, all these proxies are visited before the final destination. This procedure is described in the IETF specification RFC2543bis-09.

In a first example, a SIP Route header field extension parameter is defined, e.g. ignore-in-UAS-mode. This extension parameter indicates to the AS 10 that the corresponding Route header can be ignored if the AS 10 acts as a UAS. In particular, the S-CSCF 20 adds the Route header field extension parameter ignore-in-UAS-mode to the Route header pointing back to itself. Then. If the AS 10 acts as in a proxy or B2BUA mode, the extension parameter can be ignored. On the other hand, if the AS 10 acts as a UAS, it knows that it can ignore the whole Route header containing this extension parameter.

According to the first example of the fifth embodiment, the message header may comprise the following fields:
[...]
Route: AS.operator.net; Ir
Route: S-CSCF.operator.net; Ir; ignore-in-UAS-mode;
[...]

If the AS 10 acts as a SIP proxy or B2BUA, it removes its own Route header entry and ignores the extension parameter before further routing. Then, the message header may look as follows:
[...]
Route: S-CSCF.operator.net; Ir; ignore-in-UAS-mode;
[...]

On the other hand, if the AS 10 acts as a UAS, it removes its own Route header entry and ignores the whole other Route header entry which points back to the S-CSCF 20, because the extension parameter has been added. Thus, the AS 10 generates a response, as the remaining Route header is regarded not present. This can be expressed as follows:
[...]
[...]

According to a second example, the S-CSCF 20 may insert two Route headers but this time without any marking.
[...]
Route: AS.operator.net; Ir
Route: S-CSCF.operator.net; Ir;
[...]
Then, if the AS 10 acts as a SIP proxy or B2BUA, it removes its own Route header entry and does the further routing just normally. The message header will then look as follows:
[...]
Route: S-CSCF.operator.net; Ir;
[...]

As there is a Route header left, the AS 10 cannot act as a UAS. To achieve this reaction without the risk of any undefined state of the AS 10, a corresponding definition should be set at the AS 10.

Finally, according to a third example of the fifth embodiment, the S-CSCF 20 may be arranged to insert only one Route header pointing to the AS 10, to thereby indicate to the AS 10 that it has to act as a UAS. Then, the message header only comprises the following Route header entry:
[...]
Route: S-CSCF.operator.net; Ir;
[...]

As there is no Route header back to the S-CSCF 20, the AS 10 cannot act as a SIP proxy or B2BUA, provided a corresponding definition is set at the AS 10. Thus, the AS 10 removes its own Route header entry and generates a response.

Accordingly, using the header extension parameter or settings according to the examples of the fifth preferred embodiment, it can be assured that allowable operating modes can be signaled to the AS 10, while the system functions in a correct and pre-defined way.

It is noted that the present invention is not restricted to the preferred embodiments described above. The present invention may be implemented in any proxying operation where a service request or message is proxied to an application server, to thereby indicate or negotiate allowable server operating modes. In particular, the procedures according to the preferred embodiments may be performed at any ISC or corresponding interface, e.g. also between the S-CSCF 20 and OSA SCS 40 and/or between the S-CSCF 20 and the IM-SSF 60 in FIG. 1. Furthermore, the mode information may be an information indicating non-allowed modes (e.g. forbidden modes) requested by the S-CSCF 20 or required modes of the AS 10. In the preferred embodiments, the mode information may as well be carried in the body portion or the payload portion of the signalling message. The embodiments may thus vary within the scope of the attached claims.

1. A method of proxying or relaying a message to an application server said method comprising the steps of:
a) receiving said message;
b) forwarding towards said application server a processing information indicating at least one allowable operating mode for processing said message; and
c) processing said message based on a selected one of said at least one allowable operating mode.

2. A method according to claim 1, wherein said forwarding step is performed by adding to said message at least one header field or sub-field of a header field, indicating said allowable operating modes.

3. A method according to claim 1, wherein said forwarding step is performed by adding to said message a first route header pointing to said application server and a second route header pointing back to the proxying or relaying network element.

4. A method according to claim 3, further comprising the step of adding to said second route header a header extension field indicating that said second route header is to be ignored if said application server is operated in a user agent server mode.

5. A method according to claim 1, wherein said forwarding step is performed by adding to said message only one route header pointing to said application server.

6. A method according to claim 1, wherein said forwarding step is performed by adding said processing information to a body or payload portion of said message.

7. A method according to claim 1, wherein said message is a service request.

8. A method according to claim 2, wherein said header field is an extension header field.

9. A method according to claim 1, wherein said forwarding step is performed using a mode negotiation function.

10. A method according to claim 9, wherein said mode negotiation function is performed by adding to a SIP Options message a header field indicating said allowable operating modes.

11. A method according to claim 9, wherein said mode negotiation is performed during a registration to said application server.

12. A method according to claim 1, further comprising the step of checking the possibility of said forwarding step by adding a corresponding requirement information to said message.

13. A method according to claim 12, wherein said requirement information is a predetermined tag in a Proxy-Require header field of said message.

14. A method according to claim 7, wherein said service request is a SIP request.

15. A method according to claim 1, wherein said processing information is added to a filter information.

16. A method according to claim 1, wherein said allowable operating modes comprise at least one of a proxy server mode, a back-to-back user agent mode, a user agent server mode and a user agent client mode.

17. A system for proxying or relaying a message to an application server, said system comprising:
a) session control means for receiving said message and for generating and forwarding towards said application server a processing information indicating at least one allowable operating mode for processing said message;
b) wherein said application server is arranged to process said message based on a selected one of said at least one allowable operating modes.

18. A system according to claim 17, wherein said session control means is a Call State Control Function of an IP multimedia subsystem.

19. A system according to claim 17, wherein said application server is a SIP application server.

20. A network element for proxying or relaying a message to an application server said network element being arranged to generate and forward towards said application server a processing information indicating at least one allowable operating mode for processing said message.

21. A network element according to claim 20, wherein said network element is arranged to forward said processing information in a payload or body portion, a header field or a sub-field of a header field of said message.

22. A network element according to claim 20, wherein said network element is arranged to forward said processing information in a mode negotiation procedure.

23. A network element according to claim 20, wherein said network element is arranged to add a predetermined tag to a proxy requirement header of said message to check the availability of said forwarding function.

24. A network element according to claim 20, wherein said network element is a Call State Control Function of an IP multimedia subsystem.

25. An application server for receiving a message proxied or relayed from a network element, said application server being arranged to process said message based on a processing information received from said network element and indicating at least one allowable operating mode for said processing.

26. An application server according to claim 25, wherein said application server is arranged to determine said processing information from a header field of said message.

27. An application server according to claim 25, wherein said application server is arranged to determine said processing information based on a mode negotiation function.
